(19) United States
(12) Patent Application Publication
(10) Pub. No.: US 2008/0127782 A1
(43) Pub. Date: Jun. 5, 2008

(54) Wrist-worn opening device

(76) Inventor: Charles O'Brien, Park City, UT (US)

Correspondence Address: VAN COTT, BAGLEY, CORNWALL & MCCARTHY, P.O. BOX 45340, SALT LAKE CITY, UT, 84145-0340, US

(21) Appl. No.: 11/879,203

(22) Filed: Jul. 16, 2007

Related U.S. Application Data
(60) Provisional application No. 60/830,994, filed on Jul. 14, 2006.

(51) Int. Cl. B67B 7/44

(52) U.S. Cl. 81/3.09

(57) ABSTRACT

An apparatus for removing a cap from a bottle is disclosed. The apparatus comprises a wrist band and an opening member secured to the wrist band. One embodiment of the opening member includes a central cutout portion having a first end configured to engage the top portion of a cap and a second end configured to engage the underside of the downwardly extending ridge portions of the cap. The opening member may be secured to the wrist band using a pair of attaching assemblies comprising leather or Velcro strips that are secured to the wrist band proximate first and second sides of the opening member using grommets or snap assemblies or an attaching strip that is threaded through openings proximate first and second sides of the opening member and that has first and second ends attached to corresponding first and second ends of the wrist band using grommets or snap assemblies.

### RELATED APPLICATIONS

This present application claims priority to U.S. Provisional Patent Application Ser. No. 60/830,994, filed Jul. 14, 2006.

### TECHNICAL FIELD OF THE INVENTION

The present invention relates to container openers and, specifically, container openers of the type that can be secured to a wrist band and worn on the wrist.

### BACKGROUND OF THE INVENTION

Beverage containers—such as bottles of beer or soda having caps—are ubiquitous in the service industry. Bartenders and wait staff, for example, may find it necessary to open hundreds or thousands of such containers on a daily or weekly basis. Frequently, the caps on such containers are difficult to remove. Caps on beer bottles are generally pried off using a bottle opener, or twisted off by grasping a plurality of sharp ridges positioned around the edge of the cap. When a bartender or waiter is required to remove the cap from a bottle, a bottle opener is frequently not within easy reach or has been misplaced, requiring the bartender or waiter to use his or her bare hands to remove the cap. The use of bare hands to remove the caps from several bottles in a short period of time can result in unpleasant cuts to the hand. The present invention provides a convenient means to have an opening device worn on the wrist of a user, thereby reducing the likelihood of misplacing a more conventional hand-held opener and thus reducing the need to remove caps from bottles using the bare hand.

### SUMMARY OF THE INVENTION

An apparatus for removing a cap from a bottle, comprising a wrist band having a first end and a second end configured to be secured to the first end and an opening member secured to the wrist band. One embodiment of the opening member includes a central cutout portion having a first end configured to engage the top portion of a cap and a second end configured to engage the underside of the downwardly extending ridge portions of the cap. The opening member may be removably secured to the wrist band using a pair of attaching assemblies, which include either a strip of leather secured to the wrist band using a snap member or a first Velcro portion adhesively secured to the wrist band and a second Velcro portion adhesively secured to the opening member. In various embodiments, the opening member is constructed using steel, aluminum or plastic, while the wrist band is constructed using leather or plastic.

Further embodiments include an attaching strip threadedly connecting with the opening, member and having first and second ends secured to corresponding first and second ends of the wrist band. Additional embodiments further include male and female sections of a snap assembly positioned at the first and second ends, respectively, of the wrist band for securing the wrist band about the user's wrist. Yet additional embodiments further include male and female or opposing sections of Velcro positioned at the first and second ends, respectively, of the wrist band for securing the wrist band about the user's wrist. Yet still further embodiments include a watch threadedly connected to the attaching strip.

A method for removing a cap from a bottle includes providing a bottle opening apparatus having a wrist band and an opening member connected thereto, the opening member having a central cutout portion having a first edge configured to seat atop the bottle cap and a second or opposing edge configured to engage the ridges of the cap, positioning the opening member against the cap and rotating the wrist about an axis extending through the wrist until the cap becomes dislodged from the bottle. A further embodiment of the method includes placing the user's thumb against the opening member to generate a leverage that assists removal of the cap during the rotation of the wrist.

### BRIEF DESCRIPTION OF THE DRAWINGS

FIG. 1 illustrates an overhead view of a first embodiment of the wrist worn bottle opener of the present invention;

FIG. 2 illustrates a side view of the embodiment illustrated in FIG. 1;

FIG. 3 illustrates an over head view of a second embodiment of the wrist worn bottle opener of the present invention;

FIG. 4 illustrate a bottle having the cap secured to the opening prior to removal;

FIG. 5 illustrates an embodiment of the opening device of the present invention placed into position against the cap for removal;

FIG. 6 illustrates the user's thumb being placed against an embodiment of the present invention to assist with leverage for removing the cap from the bottle;

FIG. 7 illustrates the rotation of the wrist in the process of removing the cap from the bottle using an embodiment of the present invention;

FIG. 8 illustrates the further rotation of the wrist thereby finally removing the cap from the bottle using an embodiment of the present invention;

FIG. 9 illustrates an overhead view of an additional embodiment of the wrist worn bottle opener of the present invention;

FIG. 10 illustrates a side view of the embodiment illustrated in FIG. 9;

FIG. 11 illustrates an overhead view of an additional embodiment of the wrist worn bottle opener of the present invention;

FIG. 12 illustrates a side view of the embodiment illustrated in FIG. 11;

FIG. 13 illustrates an overhead view of an additional embodiment of the wrist worn bottle opener of the present invention;

FIG. 14 illustrates a side view of the embodiment illustrated in FIG. 13;

FIG. 15 illustrates a side view of the embodiment illustrated in FIG. 13 in assembled fashion as would appear about the wrist of a user;

FIG. 16 illustrates an underside view as would appear about the wrist showing, the opening member of the embodiment illustrated in FIG. 13; and

FIG. 17 illustrates an above side view as would appear about the wrist showing the watch of the embodiment illustrated in FIG. 13.

### DETAILED DESCRIPTION OF THE INVENTION

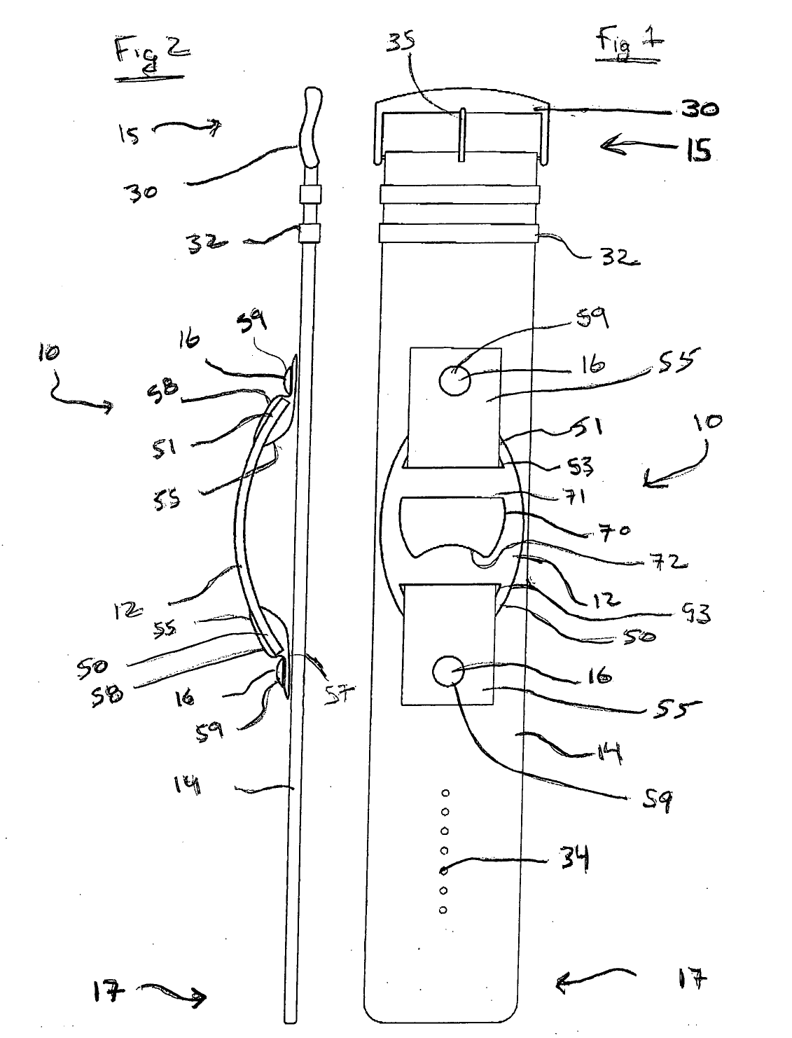

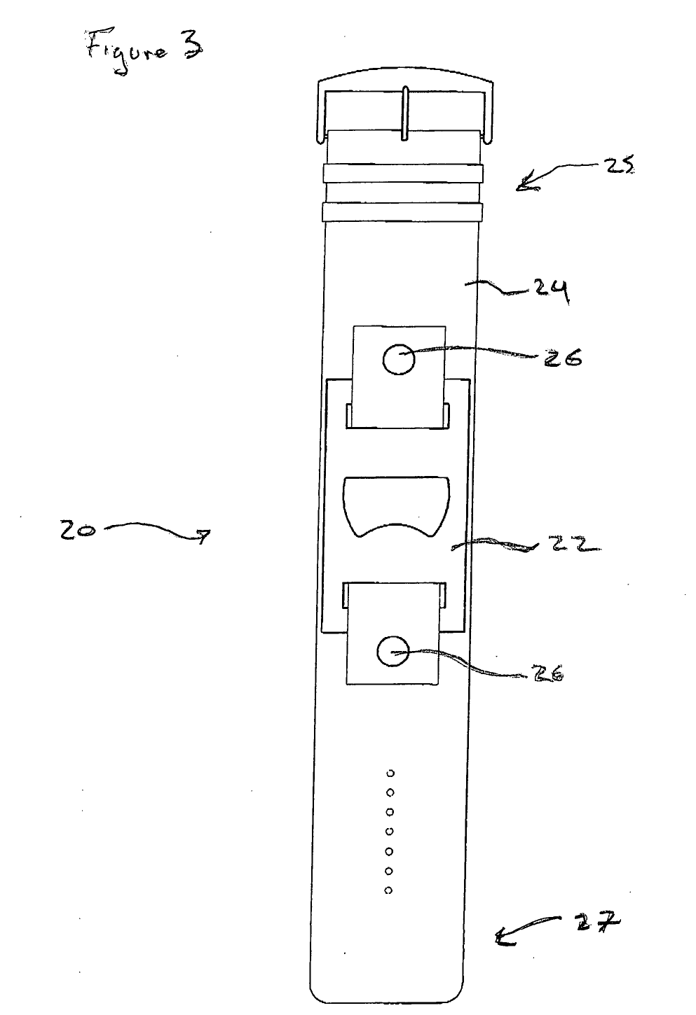

The present invention relates generally to a bottle opener worn on the wrist of the user. Referring to FIGS. 1 and 2, for example, a first embodiment of a bottle opener 10 includes an opening member 12, a wrist band 14 having a first end 15 and a second end 17, and a pair attaching assemblies 16. Referring to FIG. 3, a second embodiment of a bottle opener 20 includes, likewise, an opening member 22, a wrist band 24 having a first end 25 and a second end 27, and a pair attaching assemblies 26. While the first embodiment illustrated in FIGS. 1 and 2 and the second embodiment illustrated in FIG. 3 exhibit differences is structure of the opening member, the differences are largely cosmetic; accordingly, the principle elements and structural features of the present invention are described and discussed generically with respect to FIGS. 1 and 2.

Referring to FIGS. 1 and 2, the wrist band 14 is configured in a manner similar to a conventional watch band. The wrist band includes a first end 15 and second end 17 configured to secure the band about the wrist of a user. Specifically, the first end 15 includes a latching assembly 30 and one or more loop members 32 for securing the second end 17 to the first end 15. The second end 17 includes a series of holes 34 that are sized to engage a latch member 35 of the latching assembly 30, with the first 15 and second ends 17 finally secured in a fashion similar to that employed with a watch band or belt buckle.

The opening member 12 is illustrated as removeably attached to the wrist band 14 using a pair of attaching assemblies 16. More specifically, the opening member 12 comprises a substantially flat piece of metal (e.g., steel or aluminum) having a first end 50 and a second end 51. The opening member 12 exhibits a moderate degree of curvature along the length between the first 50 and second ends 51 to accommodate the curvature of the user's wrist. While a curved opening member 12 in this regard is preferred, the opening member may be flat or substantially flat between the first 50 and second 51 ends. A slotted opening 53 is cut into the opening member 12 proximate each of the first 50 and second ends 51. A pair of attaching assemblies 16 is secured to the wrist band 14 using any suitable means typically found on a band for a wrist watch. For example, each attaching assembly may comprise a strip of leather or plastic 55 that is secured at one end 57 to the wrist band 14 using a base portion (not illustrated) of a snap assembly. A second end 58 of the strip 55 includes a top portion 59 of the snap assembly. The second end 58, including the top portion 59 of the snap assembly, is configured for threading through the slotted opening 53, and the base 57 and top 58 portions of the strip 55 are then secured to one another in typical fashion using the snap assembly, thereby securing the opening member 12 to the wrist band 14.

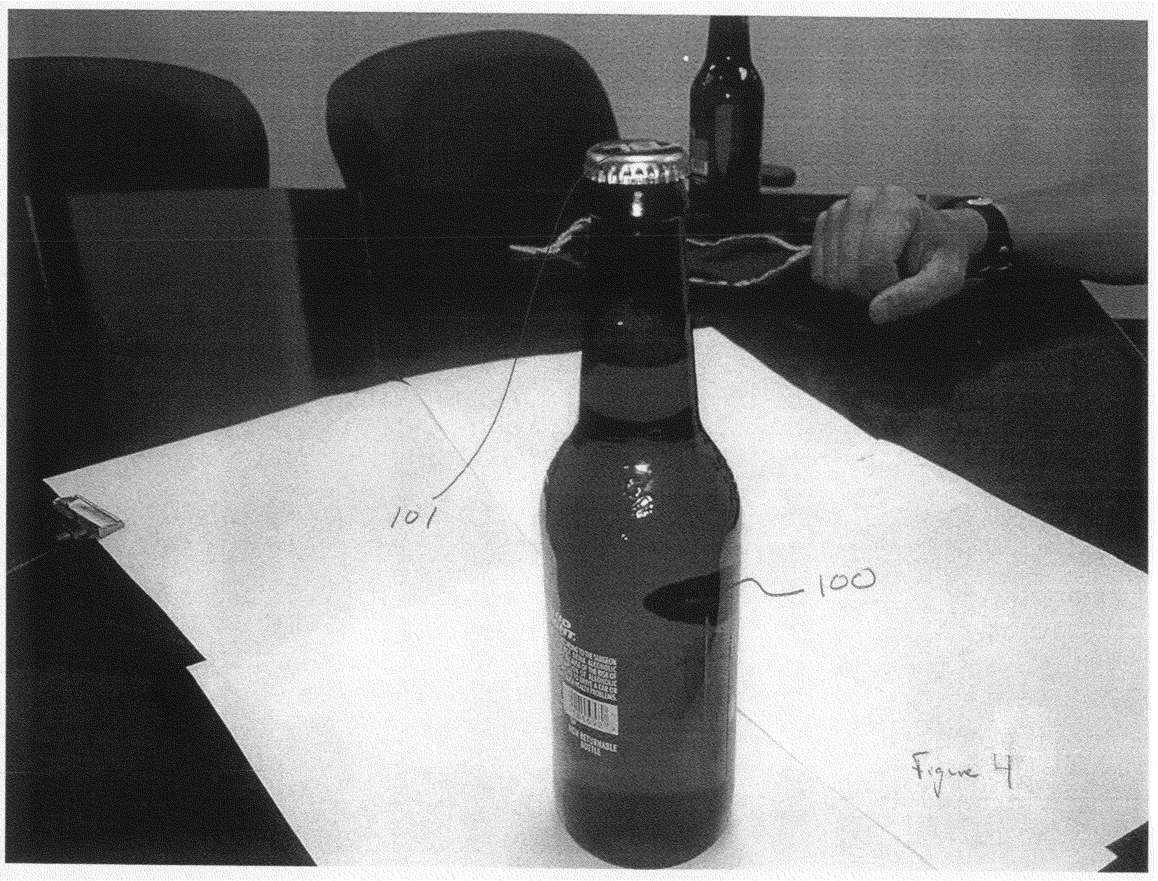

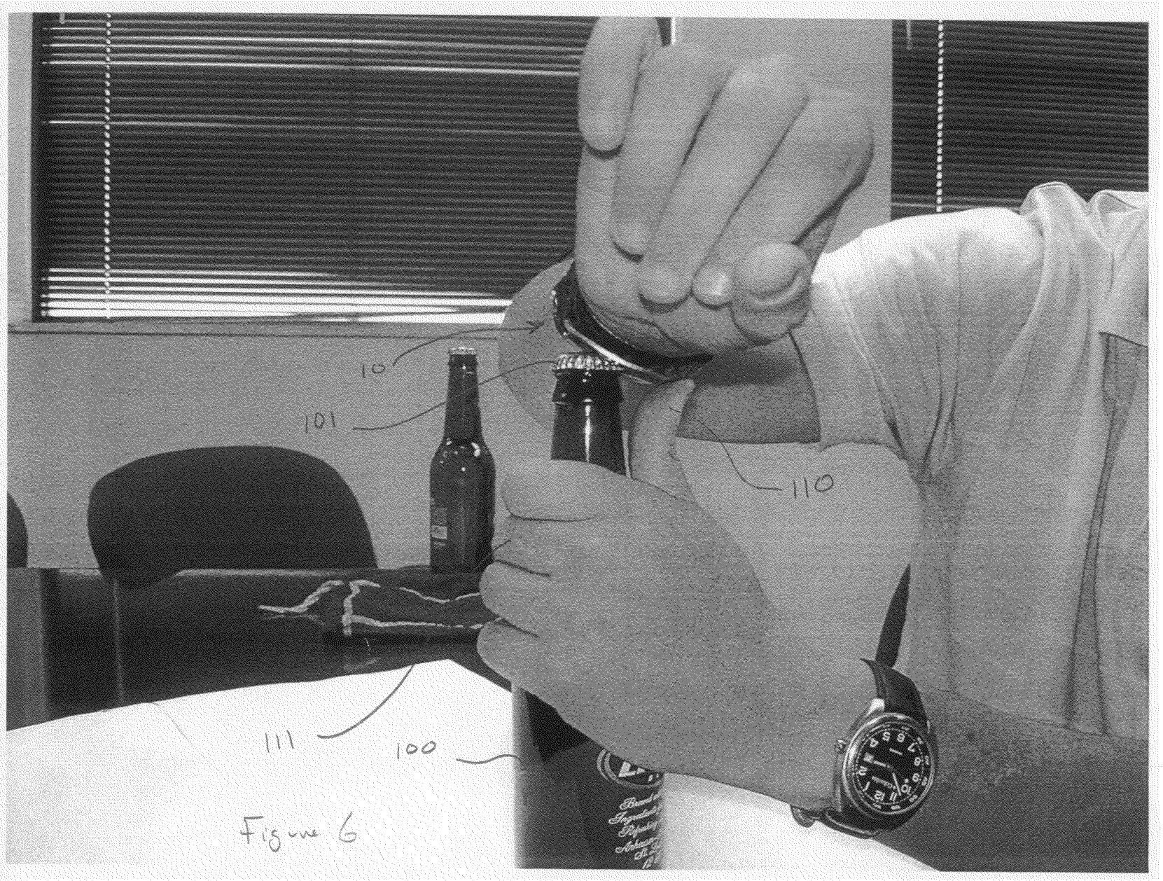

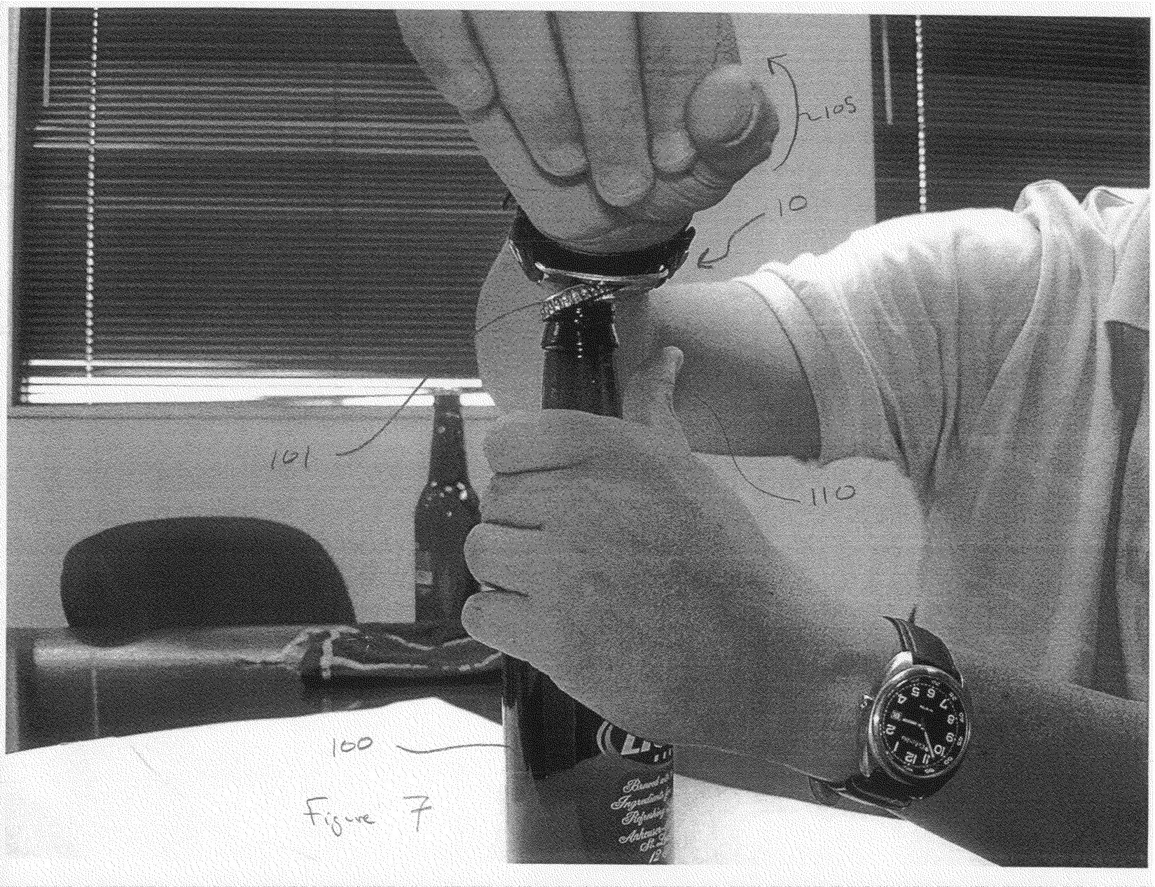

The opening member 12 further includes a central cutout portion 70. The central cutout portion 70 is shaped and configured to engage and remove the cap from a bottle. More specifically, the central cutout portion 70 includes a first end 71 and a second end 72. The first end 71 is substantially straight and shaped and configured to rest upon the typically flat portion of the top of a cap 101 secured to a bottle 100 (see, for example, FIGS. 4-8). The second end 72 is generally curved and shaped and configured to engage the underside of the cap 101 extending down and about the circumference of the opening of the bottle 100. As one having skill in the art will recognize, the opening member 12, including the first end 71 and second end 72 of the central cutout portion 70, may exhibit varying degrees of curvature along to accommodate varying curvatures of the wrists of users, and may also exhibit varying degree of curvature to accommodate varying sizes and configurations of caps and bottles. At the same time, one embodiment of the opening member exhibits no curvature, being essentially flat along the length of the opening member. A second embodiment of the opening member exhibits curvature substantially equal to the typical curvature of an adult user's wrist.

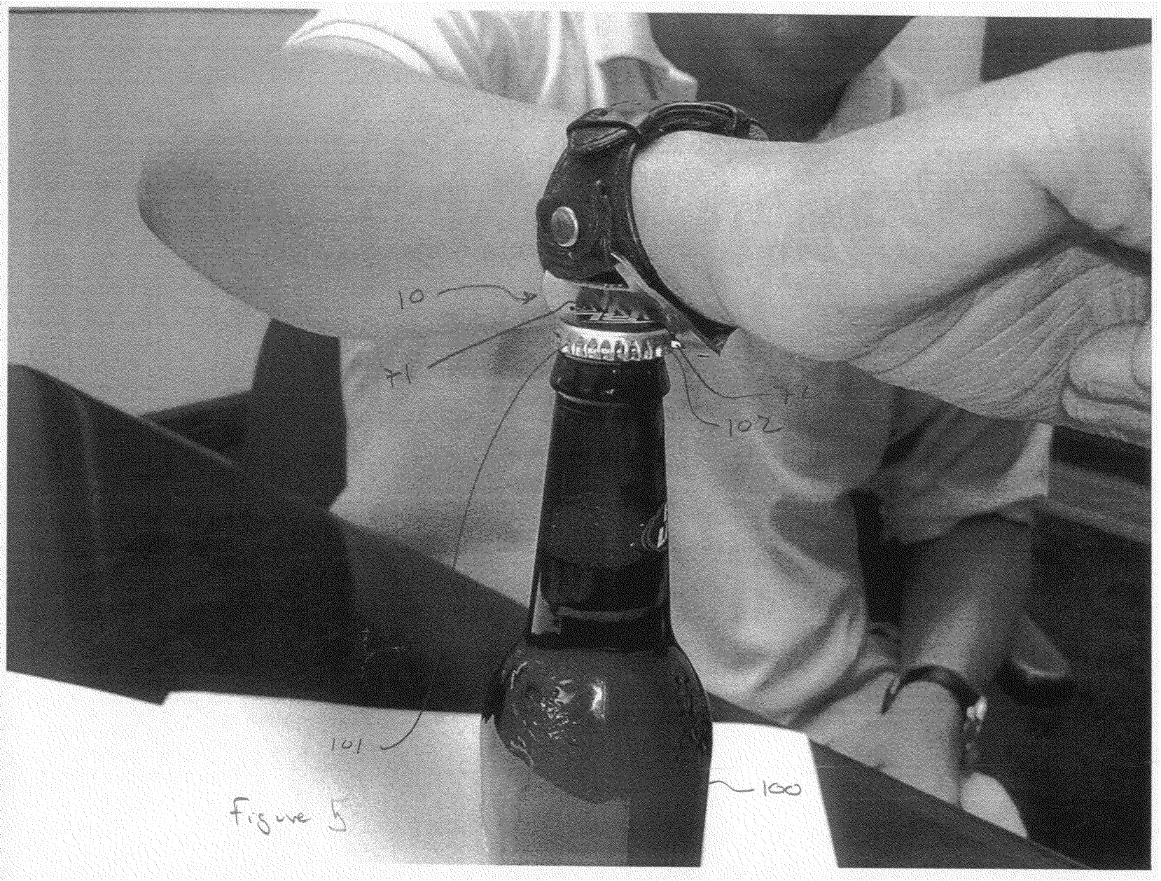

Referring now to FIGS. 4-8, one embodiment of the present invention is illustrated through various stages of removing a cap 101 from a bottle 100. Specifically, FIG. 4 illustrates a bottle 100 having a cap 101 securely fastened thereto. Referring now to FIG. 5, the bottle opener 10 is positioned against the cap 101, with the first end 71 of the central cutout portion 70 placed against the top portion of the cap 101 and the second end 72 of the central cutout portion 70 engaging one or more of the ridges 102 of the cap 101 that extend downward from the top of the cap 101 and secure the cap 101 to the bottle 100. Referring now to FIG. 6, the user's thumb 110 is illustrated pushing against the opening member 12 proximate the second end 72 of the central cutout portion 70 while, at the same time, the user's fingers 111 grasp the neck portion of the bottle 100. Referring now to FIGS. 6 through 8, operation of the bottle opener 10 is illustrated proceeding from the thumb 110 pushing against the opening member 12 to initiate the cap removal sequence to the wrist rotating 105 about an axis generally perpendicular to the axis of the bottle 100 and finally removing the cap 101 from the bottle 100 to complete the cap removal sequence. Once the cap 101 is removed from the bottle 100, the cap may be disposed.

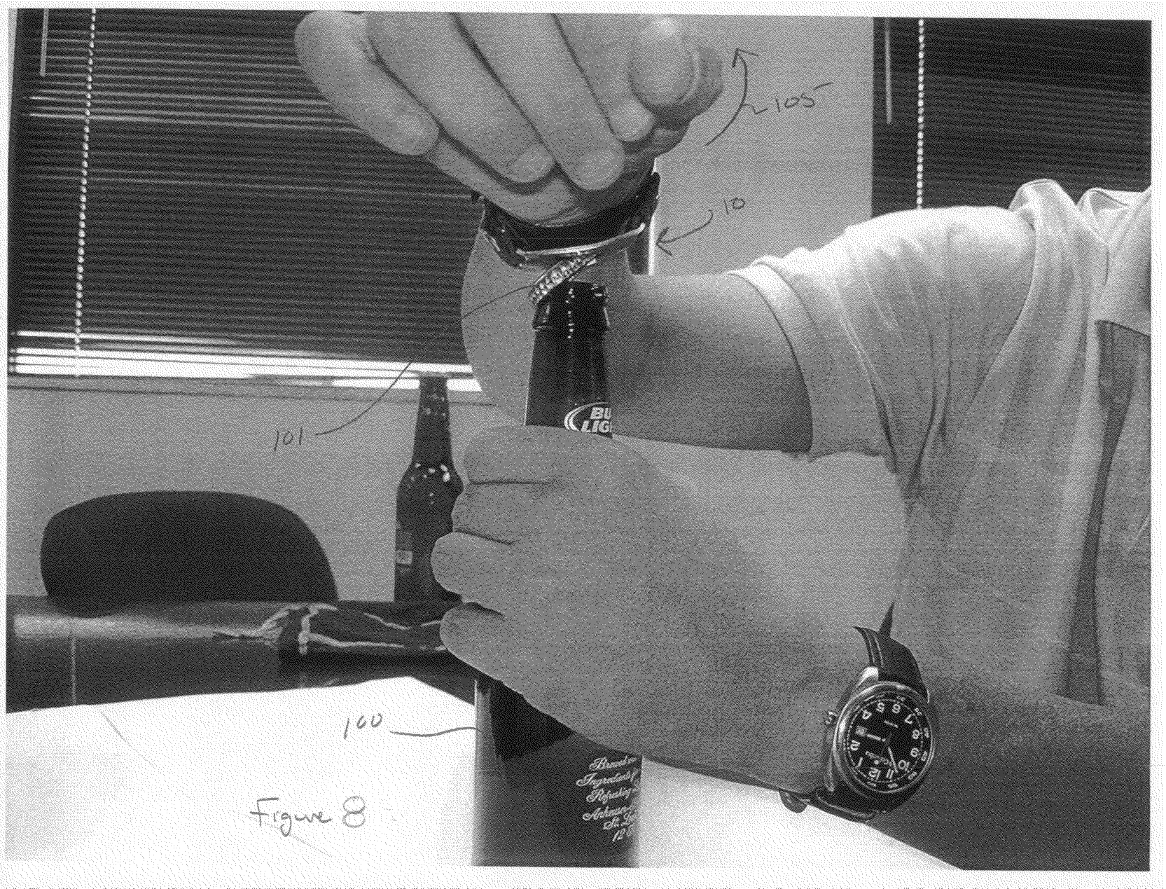

Referring now to FIGS. 9 and 10, a further embodiment of the opening device of the present invention is disclosed. More specifically, a bottle opener 113 includes an opening member 112, a wrist band 114 having a first end 115 and a second end 117, and an attaching strip 116. The opening member 112 comprises a substantially flat piece of metal (e.g., steel or aluminum) having a first end 150 and a second end 151. The opening member 112 exhibits a moderate degree of curvature along the length between the first 150 and second ends 151 to accommodate the curvature of the user's wrist. While a curved opening member 112 in this regard is preferred, the opening member may be flat or substantially flat between the first 150 and second 151 ends. A slotted opening 153 is cut into the opening member 112 proximate each of the first 150 and second ends 151. The attaching strip 116 has a first end 180 that is threaded through the slotted opening 153 at the first end 150 from an upper surface 183 side of the opening member 112, traversed along a lower surface 184 of the opening member 112 from the first end 150 to the second end 151, and then threaded from the lower surface 184 through the slotted opening at the second end 151.

The first end 180 of the attaching strip 116 is secured to the first end 115 of the wrist band 114 using an upper or female snap section 190 of a snap assembly. The second end 181 of the attaching strip 116 is secured to the second end 117 of the wrist band 114 using a lower or male section 191 of the snap assembly. The upper 190 and lower 191 sections of the snap assembly are secured to the layered wrist band and attaching strip using standard techniques—e.g., as disclosed in U.S. Pat. No. 5,441,187 (Mixson), the disclosure of which is incorporated herein by reference. When constructed in this fashion, a user places the backside of the wrist band 114 about his or her wrist and snaps the male 191 and female 190 sections of the snap assembly together, thereby removably securing the bottle opener 113 to the user's wrist. The bottle opener 113 may then be used in a manner similar to that described above for removing the cap from a beverage bottle.

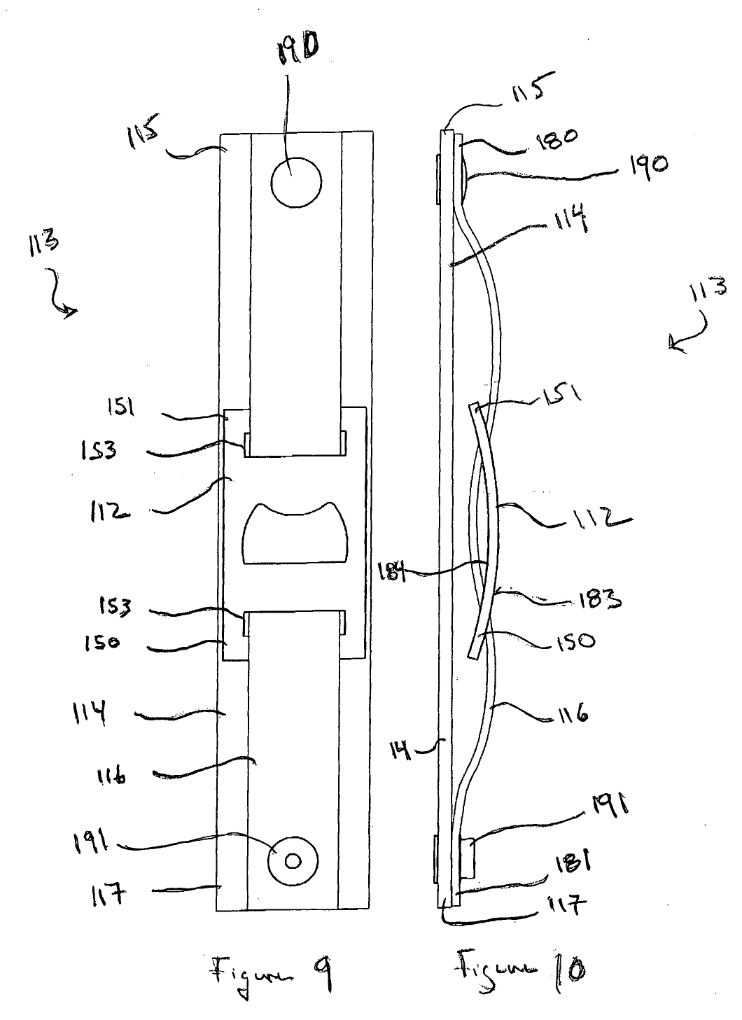

Referring now to FIGS. 11 and 12, a further embodiment of the opening device of the present invention is disclosed. More specifically, a bottle opener 213 includes an opening member 212, a wrist band 214 having a first end 215 and a second end 217, and an attaching strip 216. The opening member 212 comprises a substantially flat piece of metal (e.g., steel or aluminum) having a first end 250 and a second end 251. The opening member 212 exhibits a moderate degree of curvature along the length between the first 250 and second ends 251 to accommodate the curvature of the user's wrist. While a curved opening member 212 in this regard is preferred, the opening member may be flat or substantially flat between the first 250 and second 251 ends. A slotted opening 253 is cut into the opening member 212 proximate each of the first 250 and second ends 251. The attaching strip 216 has a first end 280 that is threaded through the slotted opening 253 at the first end 250 from an upper surface 283 side of the opening member 212, traversed along a lower surface 284 of the opening member 212 from the first end 250 to the second end 251, and then threaded from the lower surface 284 through the slotted opening at the second end 251.

The first end 280 of the attaching strip 216 is secured to the first end 215 of the wrist band 214 using an adhesive or grommet fastener. The second end 281 of the attaching strip 216 is secured to the second end 217 of the wrist band 214 using a similar adhesive or grommet fastener. A first female Velcro strip 290 is secured to an upper side portion of the attaching strip 216 proximate the first end 215 of the wrist band 214. A second male Velcro strip 292 is secured to a lower side of the wrist band 216 proximate the second end 217 of the wrist band 214. The Velcro strips may secured to the wrist band and attaching strip using adhesive or other suitable securing structure, such as, by way of example, a grommet. When constructed in this fashion, a user places the backside of the wrist band 214 about his or her wrist and places the female 290 and male 292 sections of the Velcro strips together, thereby removably securing the bottle opener 213 to the user's wrist. The bottle opener 213 may then be used in a manner similar to that described above for removing the cap from a beverage bottle.

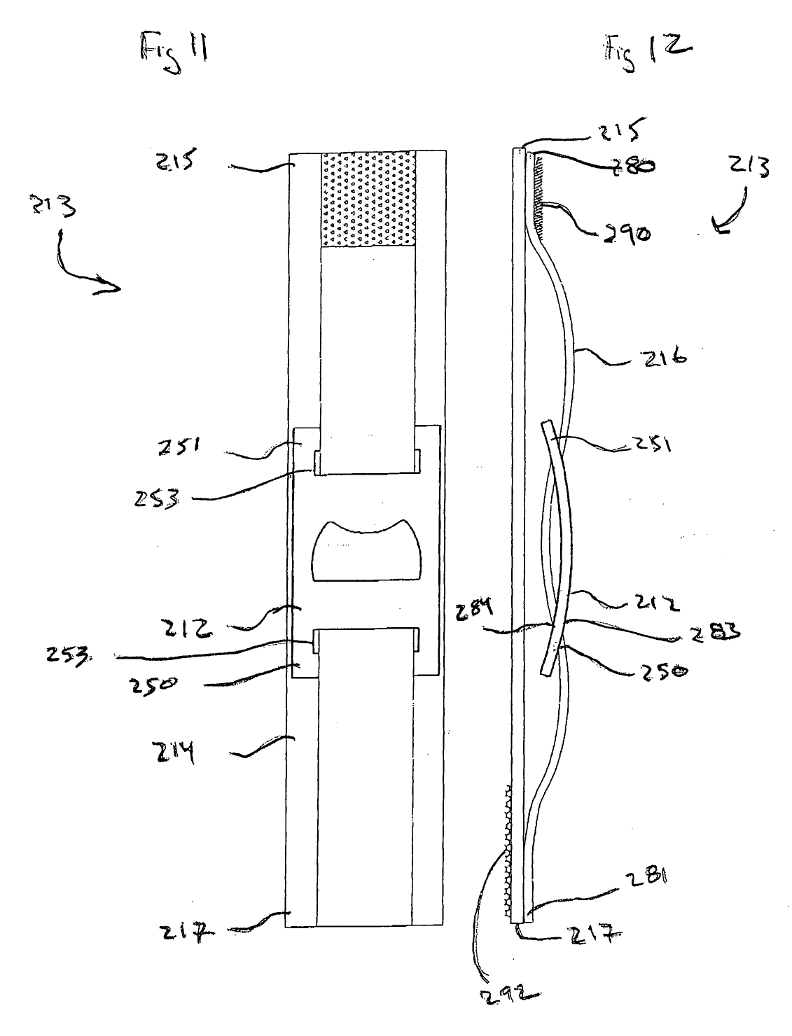

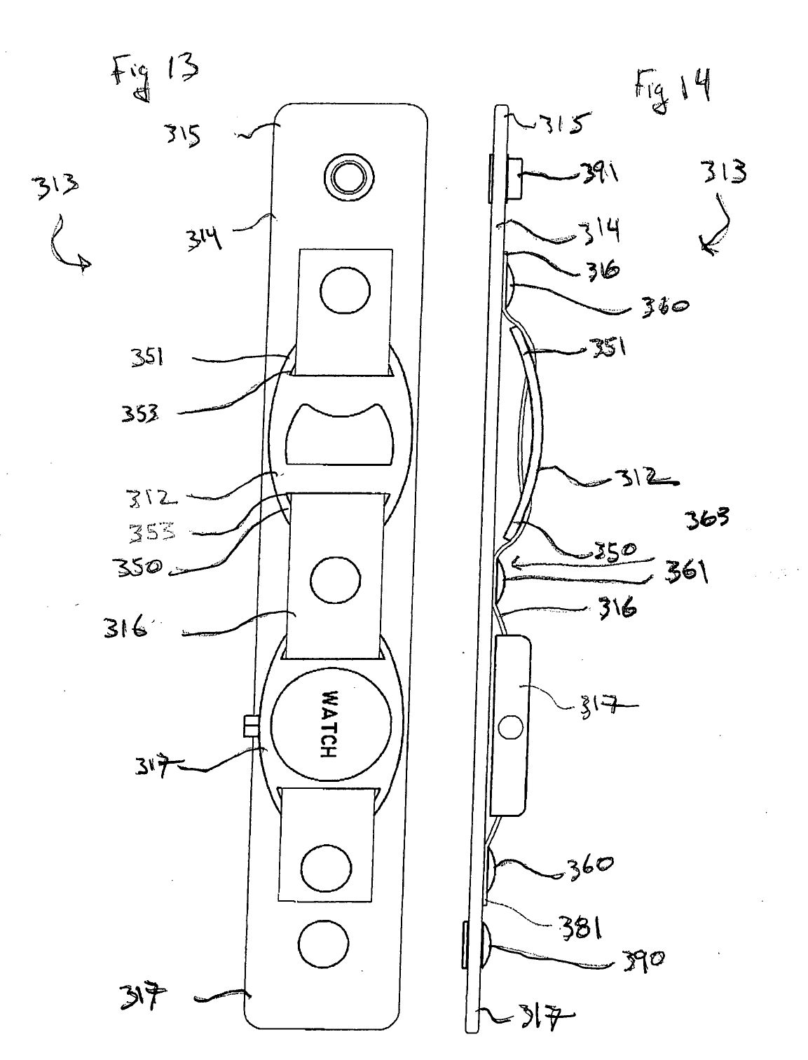

Referring now to FIGS. 13 and 14, a further embodiment of the opening device of the present invention is disclosed. More specifically, a bottle opener 313 includes an opening member 312, a wrist band 314 having a first end 315 and a second end 317, a watch 317 or similar wrist worn device or ornament and an attaching strip 316. The opening member 312 comprises a substantially flat piece of metal (e.g., steel or aluminum) having a first end 350 and a second end 351. The opening member 312 exhibits a moderate degree of curvature along the length between the first 350 and second ends 351 to accommodate the curvature of the user's wrist. While a curved opening member 312 in this regard is preferred, the opening member may be flat or substantially flat between the first 350 and second 351 ends. A slotted opening 353 is cut into the opening member 312 proximate each of the first 350 and second ends 351. The attaching strip 316 has a first end 380 that is threaded through the slotted opening 353 at the first end 350 from an upper surface 383 side of the opening member 312, traversed along a lower surface 384 of the opening member 312 from the first end 350 to the second end 351, and then threaded from the lower surface 384 through the slotted opening at the second end 351. The watch 317 is secured to the wrist band 314 using the attaching strip 316 in a fashion similar to that just described.

The first end 380 of the attaching strip 316 is secured proximate the first end 315 of the wrist band 314 using a grommet 360 or similar attaching device. The second end 381 of the attaching strip 316 is secured proximate the second end 317 of the wrist band 314 also using a grommet 360 or similar attaching device. A third grommet 361 is used to attach an intermediate portion 363 of the attaching strip 316—defined by the section of the attaching strip in between the opening member 312 and the watch 317—to the wrist band 314 in order to separate the opening member 312 and the watch 317 and to secure both the opening member 312 and watch 317 to the wrist band 314. An upper or female snap section 390 of a snap assembly is attached to the wrist band 314 proximate the second end 317 and a lower or male snap section 391 of a snap assembly is attached to the wrist band 314 proximate the first end 315. The upper 390 and lower 391 sections of the snap assembly are secured to the wrist band using standard techniques. When constructed in this fashion, a user places the backside of the wrist band 314 about his or her wrist and snaps the male 391 and female 390 sections of the snap assembly together, thereby removably securing the bottle opener 313 to the user's wrist. The bottle opener 313 may then be used in a manner similar to that described above for removing the cap from a beverage bottle.

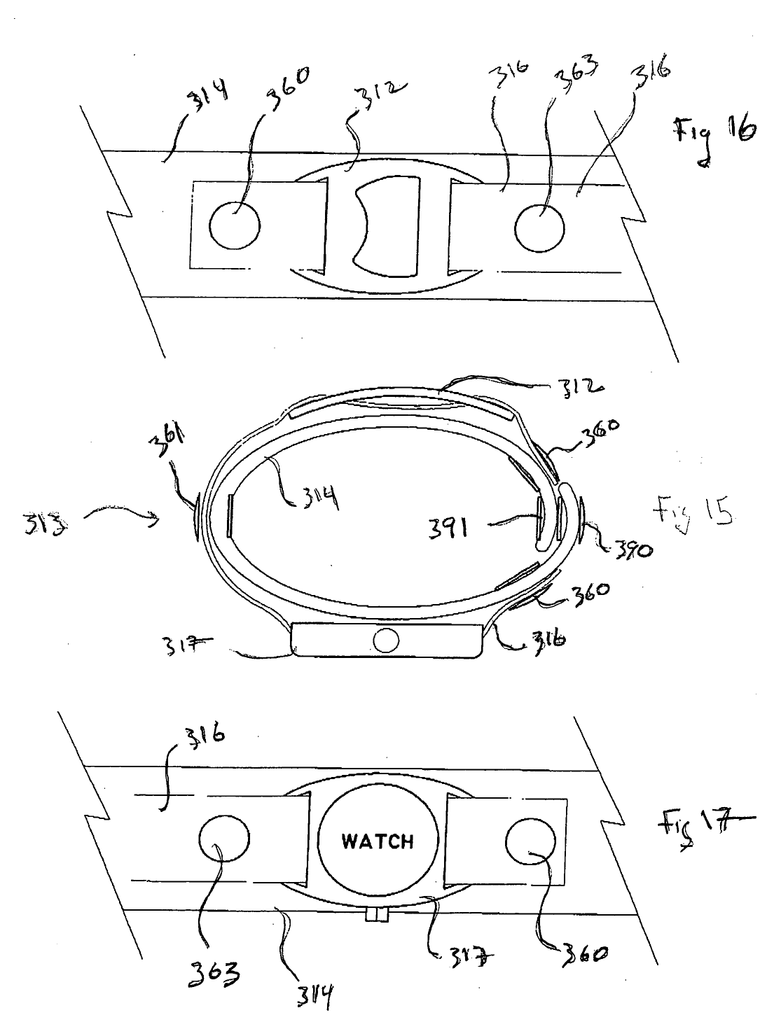

Referring not to FIGS. 14-17, the embodiment of the opening device 313 just described is illustrated as would be fastened about the wrist of a user. On the underside of the user's wrist is the opening member 312 positioned for removing the cap from a bottle as described previously. On the upper side of the user's wrist is the watch 317 as normally positioned on a conventional watch band for observing time.

While certain embodiments and details have been included herein and in the attached invention disclosure for purposes of illustrating the invention, it will be apparent to those skilled in the art that various changes in the methods and apparatuses disclosed herein may be made without departing form the scope of the invention, which is defined in the appended claims.

What is claimed is:

1. An apparatus for removing a cap from a bottle, comprising:
a wrist band having a first end and a second end configured to be secured to the first end; and
an opening member secured to the wrist band.

2. The apparatus of claim 1, wherein the opening member includes a central cutout portion having a first end configured to engage the top portion of the cap and a second end configured to engage the underside of the downwardly extending ridge portions of the cap.

3. The apparatus of claim 1, wherein the opening member is removably secured to the wrist band.

4. The apparatus of claim 1, wherein the opening member is removably secured to the wrist band using a pair of attaching assemblies.

5. The apparatus of claim 4, wherein the attaching assemblies include a strip of leather secured to the wrist band using a snap member.

6. The apparatus of claim 4, wherein the attaching assemblies include a first Velcro portion adhesively secured to the wrist band and a second Velcro portion adhesively secured to the opening member.

7. The apparatus of claim 1, wherein the opening member is constructed from the group consisting of steel, aluminum and plastic.

8. The apparatus of claim 1, wherein the wrist band is constructed from the group consisting of leather and plastic.

9. The apparatus of claim 1, wherein the first end of the wrist band is removably secured to the second end of the wrist band using a snap assembly.

10. The apparatus of claim 1, wherein the first end of the wrist band is removably secured to the second end of the wrist band using Velcro.

11. An apparatus for removing a cap from a bottle, comprising:
a wrist band having a first end and a second end configured to be secured to the first end;
an opening member; and
an attaching strip securing the opening member to the wrist band.

12. The apparatus of claim 11, wherein the opening member has a pair of openings configured to threadedly receive the attaching strip.

13. The apparatus of claim 12 wherein the attaching strip has a first end secured to a first end of the wrist band and a second end secured to a second end of the wrist band.

14. The apparatus of claim 13, wherein a first grommet secures the first end of the attaching strip to the first end of the wrist band.

15. The apparatus of claim 14, wherein a second grommet secures the second end of the attaching strip to the second end of the wrist band.

16. The apparatus of claim 15 wherein the first grommet includes a male snap portion extending above a first surface of the wrist band and the second grommet includes a female snap portion configured to engage the male portion and extending below a second surface of the wrist band.

17. The apparatus of claim 16, wherein the second surface wraps about and contacts a user's wrist when the wrist band is wrapped about the wrist.

18. The apparatus of claim 17, further comprising a watch threadedly connected to the attaching strip.

19. A method for removing a cap from a bottle, comprising the steps:
providing a wrist worn apparatus for removing a cap from a bottle, the apparatus comprising a wrist band having a first end and a second end configured to be secured to the first end and an opening member secured to the wrist band, said opening member having a cutout portion having a first end and an opposing end;
positioning the first end of the opening member against a top portion of the cap and the opposing end against one or more ridges of the cap;
rotating the wrist about an axis extending through the wrist until the cap is removed from the bottle.

20. The method of claim 19, further comprising the step of placing a thumb of the user proximate the opposing edge of the opening member and applying pressure to the opening member to develop leverage to assist in removing the cap as the wrist rotates.
